(19) United States
(12) Patent Application Publication
(10) Pub. No.: US 2005/0061126 A1
(43) Pub. Date: Mar. 24, 2005

(54) Multi-dimensional miter guide

(76) Inventors: Euther Phillips, Aztec, NM (US); Lonny Ray Ludwig, Fort Worth, TX (US)

Correspondence Address: EUTHER PHILLIPS, 142 CR 2105, AZTEC, NM, 87410, US

(21) Appl. No.: 10/945,574

(22) Filed: Sep. 21, 2004

Related U.S. Application Data
(60) Provisional application No. 60/504,301, filed on Sep. 22, 2003.

(51) Int. Cl. B26D 7/06

(52) U.S. Cl. 83/438

(57) ABSTRACT

The multi-dimensional miter guide has the ability to make a three-dimensional cut in a work piece in a single pass through the cutting or sawing action of a machine. This yields a cut in the work piece that has both a horizontal angle and a vertical slope between the horizontal and vertical plane. The multi-dimensional miter guide also has the ability to sand or grind a rough cut work piece to a precise three-dimensional angle.

### BACKGROUND OF THE INVENTION

This invention relates generally to the field of sawing and cutting, and also to the field of sanding and grinding.

Miter guides have been used for many years to accomplish accurate angular cuts in work pieces. Miter guides have been invented and manufactured in simple and complex forms.

Prior technology of miter guides can be seen in the following U.S. Pat. Nos. 1,401,560; 3,841,188; 4,002,329; 5,097,601; 5,379,669; 5,771,767; 5,979,283; 6,532,679.

U.S. Pat. Nos. 5,097,601; and 6,532,679 represent simple horizontal plane miter guides. U.S. Pat. Nos. 3,841,188; 4,002,329; 5,379,669; 5,771,767; and 5,979,283 represent other devices used to achieve miter cuts in the horizontal plane by a more complex means. U.S. Pat. No. 1,401,560 represents a miter guide that produces a miter cut between the horizontal and vertical plane. U.S. Pat. Nos. 3,841,188; 4,002,329; 5,097,601; 5,379,669; 5,771,767; 5,979,283; 6,532,679 all produce a miter cut in a work piece in the horizontal plane by the miter guide rotating on a vertical axis. These miter guides do not have the ability to be adjusted in the horizontal to vertical plane by rotation of a horizontal axis. U.S. Pat. No. 1,401,560 has the ability to adjust and rotate on a horizontal axis and does not have the ability to adjust and rotate on a vertical axis. All of the previous miter guides have the limitation of only making a two dimensional cut in a work piece. The first dimension being the plane of the cutting blade and the second dimension being the plane created by the slope or angle of the miter guide that intersects the first plane or dimension.

The multi-dimensional miter has the ability to make the same angular cuts as the previously described miter guides and also adding a third dimension of cutting ability. The first dimension being the plane of the cutting blade, the second dimension being the plane of the platform where the work piece rests, and the third dimension accomplished by rotation either clockwise or counterclockwise from a perpendicular angle to the cutting blade whereby a three dimensional cut is produced at the intersect point of the three planes.

### SUMMARY OF THE INVENTION

The primary object of the invention is a miter guide that can perform a three-dimensional cut in a work piece in a single pass through a cutting or sawing machine.

Another object of the invention is a miter guide that can be used to sand or grind a work piece to a precise three-dimensional angle.

Another object of the invention is a miter guide that can be adjusted quickly.

A further object of the invention is a miter guide that is easy to use.

Other objects and advantages of the present invention will become apparent from the following descriptions, taken in connection with the accompanying drawings, wherein, by way of illustration and example, an embodiment of the present invention is disclosed.

The multi-dimensional miter guide is a device that can produce a three-dimensional cut in a work piece in a single pass through a cutting or sawing machine. The miter guide can also be used to grind or sand a work piece to a specific three-dimensional angular value. The miter guide consists of a base with a radius slotted adjustment path, a work platform, a slotted slope adjustment arm, a slide guide, a degree pointer and a work piece guide plate. The slide guide is attached to bottom of the base which travels the guide groove of a machines work table parallel to the machines action in both directions. The base rotates and locks in many different angular orientations assisted by the degree pointer. An adjustable work platform is attached to the base at the machine end and pivots. The other end of the base and platform are connected by a slotted slope adjustment arm with many different angular orientations.

The drawings constitute a part of this specification and include exemplary embodiments of the invention, which may be embodied in various forms. It is to be understood that in some instances various aspects of the invention may be shown exaggerated or enlarged to facilitate an understanding of the invention.

BRIEF DESCRIPTION OF THE DRAWINGS

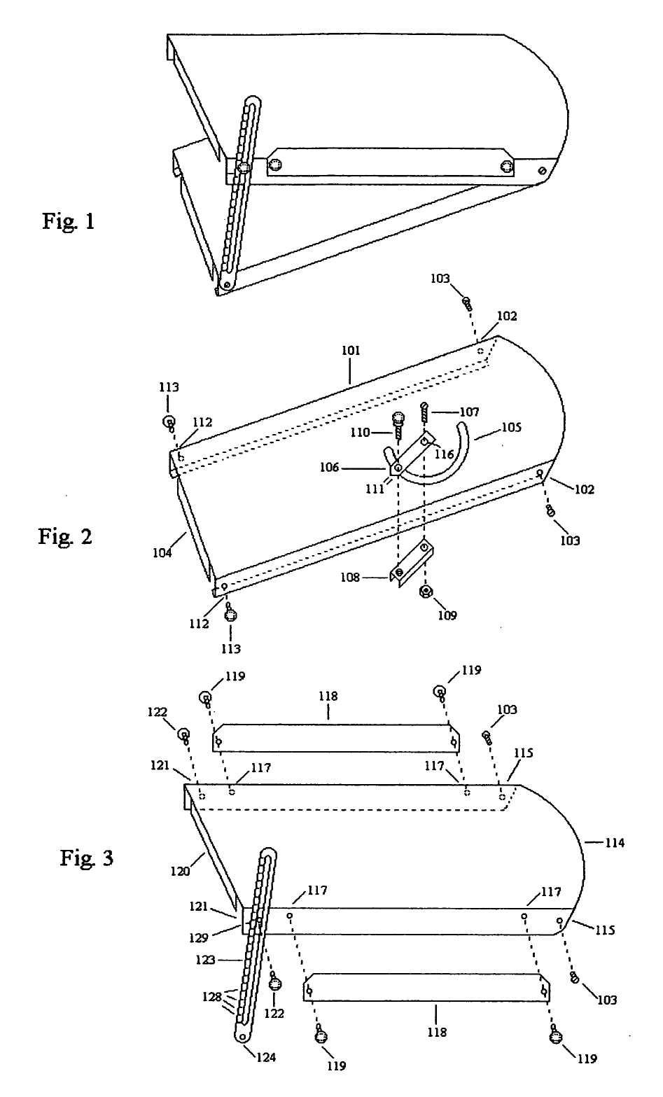

FIG. 1 is a drawing of the multi-dimensional miter guide

FIG. 2 is a drawing of the base and associated components

FIG. 3 is a drawing of the work piece platform and associated components

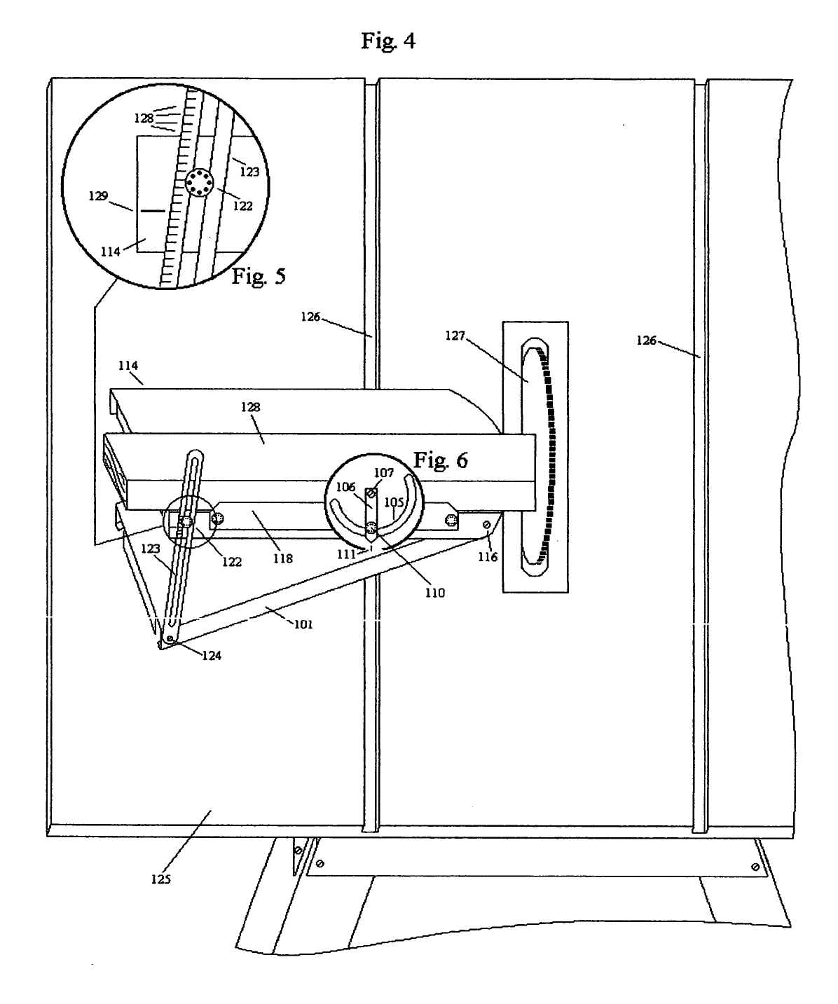

FIG. 4 is a drawing of a table saw with the miter guide in a working position

FIG. 5 is a drawing of the horizontal to vertical angular adjustment of the platform

FIG. 6 is a drawing of the rotational angular adjustment of the base

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with the present invention, FIG. 1 shows a complete drawing of an assembled multi-dimensional miter guide. FIG. 2 shows the base 101 and associated components. FIG. 3 shows the work piece platform 114 and associated components. FIG. 4 shows a drawing of a table saw 125 with the miter guide in a working position holding a work piece. FIG. 5 shows the horizontal to vertical angular adjustment of the platform. FIG. 6 shows of the rotational angular adjustment of the base 101.

The base 101 in FIG. 2 has predetermined fastening holes 102 that align with the fastening holes 115 in the platform 114 in FIG. 3 and then secured to each other by a means of fastening 103 permanently that allows for a pivoting or hinging movement.

The base 101 in FIG. 2 has a radius slotted adjustment path 105 to allow for rotation of the slide guide 108 and the angle pointer 106 which are secured by a means of permanent attaching 107 and 109 through a predetermined hole 116 in the base 101 that allows for the pivot action of the slide guide 108 independent of the base 101. A removable means of securing 110 which passes through the pointer 106, the radius slotted adjustment path 105 and then into the slide guide 108 gives the miter guide it's unique adjustability. This is the adjustment that gives the miter guide it's functional, three-dimensional ability. The removable means of securing 110 when tightened locks the base 101 in a predetermined angular setting as shown in FIG. 4 and more specifically FIG. 6. The machine facing end of the base 101 is radius or geometrically formed to allow rotation past the saw blade 127 in FIG. 4 or other cutting, sanding or grinding machines action.

The base 101 in FIG. 2 also has predetermined holes 112 at the end opposite the machine that have removable means of securing which pass though the slotted slope adjustment arm 124 in FIG. 3 at the bottom. This is the pivot action of the arm 124. The arm 124 can be moved from one side of the base 101 in FIG. 2 to the other side depending on the angular orientation of the base 101 and the work piece 128 in FIG. 4 for the preferred angle of cut.

The work piece platform 114 in FIG. 3 has predetermined holes 121 which accept a removable means of securing 122 that passes through the arm 124 and then into the platform 114. This is the slope angular adjustment for the platform 124. The platform 124 has predetermined holes 117 to accept a removable means of securing 119 that passes through the work piece guide plate 118 and into the platform 124. The plate 118 can be moved from one side to the other depending on the angular orientation of the base 101 in FIG. 2 and the work piece 128 in FIG. 4.

The base 101 in FIG. 2 has a means of reinforcing 104 at the rear and likewise the platform 114 in FIG. 3 has a means of reinforcing 120 at the rear. Adjustment of angular and slope orientations are represented by FIG. 5 and FIG. 6 which include predetermined markings. These are shown in FIG. 2 with the markings 111 in the base 101 and also in the cutaway view in FIG. 6 showing the markings 111 in the base. The adjustment and slope orientation markings for the platform 114 and the arm 123 are shown in FIG. 5. The platform 114 has a permanent marking 129 that in turn is lined up with one of the various slope orientation markings 128 on the arm 123.

The miter guides adjustments are slotted to allow for small adjustments due to variations in parallel trueness between the machine guide groove 126 in FIG. 4 and the saw blade 127.

In operation the miter guide is positioned in a predetermined angular rotational orientation that applies to the base 101 in FIG. 2 by adjusting the pointer 106 and tightening the removable means of securing 110. Then the platform 114 in FIG. 3 is adjusted to a predetermined slope orientation by aligning one of the markings 128 with the permanent marking 129 and then tightening the removable means of securing 122. Then the work piece 128 in FIG. 4 is placed on the platform 114 up against the guide plate 118. The miter guide assembly along with the work piece 128 are then moved along the guide groove 126 of the table saw 125 through the cutting action of the blade 127 thus producing a three-dimensional cut in the work piece 128 in a single pass.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A miter guide for cutting; sawing; sanding; and grinding machines that provide a guide groove in the worktable parallel to the machines cutting; sawing; sanding; or grinding action that allows the miter guide to pass the action in a parallel motion comprising of; a base with a radius slotted adjustment path; a work platform; a slotted slope adjustment arm; a slide guide; and a degree pointer; where the slide guide is attached to bottom of the base which travels the guide groove in both directions; and the base rotates about a vertical axis; and locks in many different angular orientations assisted by the degree pointer; and an adjustable work platform which is attached to the base at one end pivoting in a horizontal axis; and the other end of the base and platform are connected by a slotted slope adjustment arm with many different angular orientations.

2. The miter guide of claim 1 further including a concentric path cut in the base allowing the vertical axis rotation of the base independent of the slide guide and degree pointer; having the base; slide guide; and degree pointer attached together at the pivot end by means of permanent securing; and at the opposite end by means of removable and adjustable securing.

3. The miter guide of claim 1 further including the base having the machine facing end radius or geometrically formed to allow rotation past the cutting; sawing; sanding or grinding machines action.

4. The miter guide of claim 1 further including the platform having the machine facing end radius or geometrically formed to allow rotation past the cutting; sawing; sanding or grinding machines action.

5. The miter guide of claim 1 further including the base and platform being attached at machine action end in the horizontal pivoting or hinging axis by means of permanent securing.

6. The miter guide of claim 1 further including a removable and reversible guide plate extending above the platform edge and attached to the platform by a means of removable and adjustable securing.

7. The miter guide of claim 1 further including the slotted slope adjustment arm being attached to the base by means of permanent securing; and attached to the platform by means of removable and adjustable securing.

8. The miter guide of claim 2 further including a means of markings around the concentric path of various angular variations to align with degree pointer.

9. The miter guide of claim 7 further including a means of markings in the slotted adjustment arm of various angular variations.

10. The miter guide of claim 7 further including a means of marking an indicator in the platform to align with the slotted slope adjustment arm.
